(19) United States
(12) Patent Application Publication
(10) Pub. No.: US 2008/0143581 A1
(43) Pub. Date: Jun. 19, 2008

(54) Scanning and projection systems and methods

(75) Inventors: Barrett Kreiner, Woodstock, GA (US); Jonathan Reeves, Roswell, GA (US); John Blake Slemmer, Norcross, GA (US)

Correspondence Address: SCOTT P. ZIMMERMAN, PLLC, PO BOX 3822, CARY, NC, 27519, US

(73) Assignee: BellSouth Intellectual Property Corporation, Wilmington, DE (US)

(21) Appl. No.: 11/641,134

(22) Filed: Dec. 19, 2006

(51) Int. Cl. G01S 1/00

(52) U.S. Cl. 342/22

(57) ABSTRACT

Systems and methods described herein provide scanning, processing and projection capabilities for areas of interest. An emitter emits signals toward an area of interest. Reflected signals are received by a receiver and processed into a resulting image. The resulting image can be projected back upon a surface associated with the area of interest.

### BACKGROUND

The fields of imaging and image reproduction have been in existence for many years. In the medical imaging field, for example, X-rays and medical resonance imaging systems (MRI) are commonly used. However, both methods have their respective drawbacks. Typical X-rays generate two dimensional films and, while MRIs tend to generate a more complete picture than an X-ray, MRI films are expensive to create and take a long time to process. In other fields of use, other techniques have been used for generating images. For example, thermal imaging is used to determine hot spots.

In the architectural field, computer aided design (CAD) is often used to create structural blueprints of buildings. These blueprints can then be printed out and used in construction and planning. However, these same blueprints are not always available when needed. For example, if a fire or other incident occurs at a building, law enforcement or fire/rescue service personnel may very quickly need to know what is in or behind a wall or where a door is located. Spending valuable time to find and interpret a blueprint is undesirable under these conditions. Additionally a hostile environment could make the ability to use a blueprint in the proper place impossible, such as a smoke filled room.

Coupling an imaging device to real-time projection is potentially useful in a variety of applications and fields, such as, medical, law enforcement and construction. A low cost, high performance device capable of doing such in a variety of applications and fields would have many uses. Accordingly the present invention addresses the need for more efficient systems and methods for imaging projection.

### SUMMARY

Systems and methods according to the present invention address this need and others by providing techniques for scanning, processing and projecting an image related to an area of interest and its contents.

According to one exemplary embodiment, a system for imaging includes: an emitter, wherein the emitter emits signals toward an area of interest, a receiver, wherein the receiver receives signals that were emitted by the emitter and reflected from at least one object in the area of interest, a processor in communication with the emitter, the receiver and a projector, wherein the processor processes the received signals to generate signals for projecting an image associated with the at least one object and transmits the generated signals to the projector; and the projector, wherein the projector projects the image onto a surface associated with the at least one object.

According to another exemplary embodiment, a method for imaging includes: emitting signals toward an area of interest by an emitter, receiving the signals that were emitted by the emitter and reflected from at least one object in the area of interest, processing the received signals to generate signals for projecting an image associated with the at least one object, transmitting the generated signals to a projector, and projecting the image onto a surface associated with the at least one object by the projector.

### BRIEF DESCRIPTION OF THE DRAWINGS

The accompanying drawings illustrate exemplary embodiments of the present invention, wherein:

FIG. 1 shows a processor in communication with a UWB transceiver and a projection device according to an exemplary embodiment;

FIGS. 2(a)-(c) depict using a UWB transmitter/receiver to scan through a wall and create a projection according to an exemplary embodiment;

FIGS. 3(a)-(b) depict using a UWB transmitter/receiver to scan within a wall and creates a projection according to an exemplary embodiment;

FIG. 4 shows a projection based on scan data of what is in a wall and what is behind a wall according to an exemplary embodiment;

FIGS. 5(a)-(b) shows using a UWB transmitter/receiver to scan underground and create a projection according to an exemplary embodiment;

FIG. 6 is a flowchart illustrating a work method according to an exemplary embodiment;

FIG. 7 shows a projection of a wall structure and planned work according to an exemplary embodiment; and

FIGS. 8(a)-(b) depict using a UWB transmitter/receiver system to scan a person's body and project a resulting image onto the person's body according to an exemplary embodiment.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

In order to provide some context for this description, a brief description of ultrawideband (UWB) and radar principles which can be applied to exemplary embodiments will be described. UWB is typically considered to include systems employing a bandwidth of over 500 MHz or systems in which the fractional bandwidth used as a particular communication channel within the system exceeds 20% of the total bandwidth available to that system. Additionally, the frequency range associated with UWB systems is typically from 3.1 GHz to 10.6 GHz. Due in part to its large bandwidth, UWB is typically used in lower power communication applications.

In a simple form, a radar system consists of an emitter which emits signals, a receiver which receives signals that have been reflected back from an object, and a display. Exemplary embodiments described herein use various UWB systems in radar-like applications based upon considerations of power output, bandwidth, frequency range(s), transmission medium(s), distance, and target object composition associated with the particular application. With this quantity of parameters (many of which are modifiable), and the characteristics of UWB, a wide variety of applications exist for using UWB in radar-like applications according to these exemplary embodiments. Additionally, upon receiving the return signal(s) at the receiver, the returned signal(s) can be processed into an image, and then that image can be projected, e.g., onto a surface that was scanned, to quickly provide the users of the system with information regarding what is located within/behind objects in the scanned area.

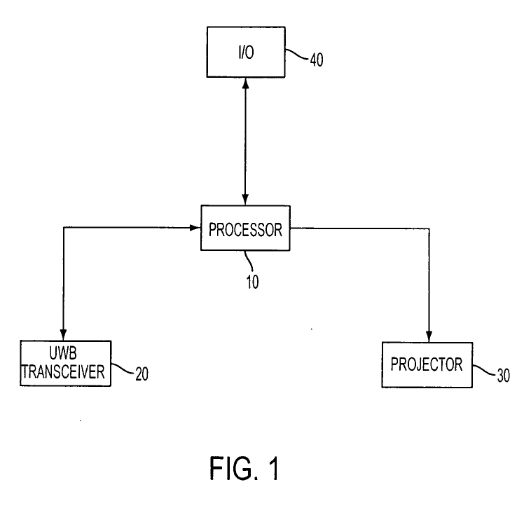

As shown in FIG. 1, exemplary scanning and projecting units described herein can include a processor 10 in communication with a UWB transceiver 20 (e.g., an emitter and a receiver) and a projection device 30. One or more I/O devices 40 (e.g., a keyboard, display, etc.) can also be provided for enabling a user to interact with the units. These scanning and projection units can be self contained or physically separate with either wired or wireless methods of communications between components. Additionally, projection device 30 can be capable of scaling the projection size of the image to be output. Various combinations of these features will be shown below according to exemplary embodiments.

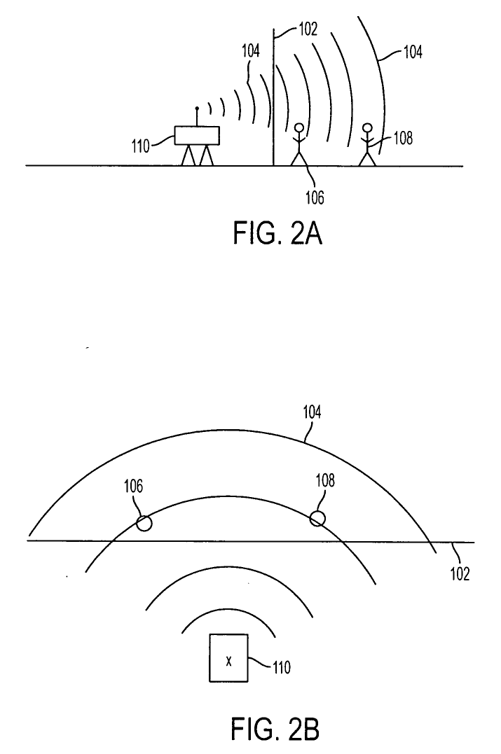

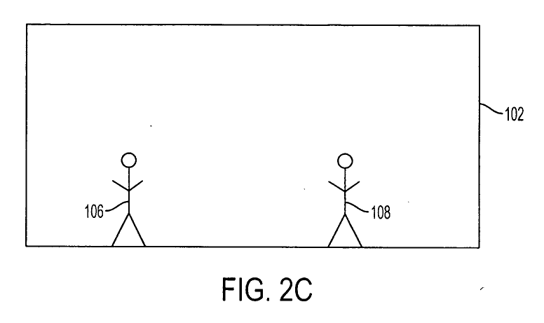

According to an exemplary embodiment, a UWB emitter transmits a signal as depicted in FIGS. 2(a) and 2(b). These waves 104 travel through a wall 102 and into the room (or other space) behind wall 102. When the transmitted signal 104 hits a target of appropriate density or reflectivity, such as person 106 and person 108, a portion of the signal is reflected back (not shown) to unit 110. Unit 110 is capable of both transmitting and receiving signals. This returned signal (not shown) is then processed by unit 110 to generate an image. The image can then be projected upon wall 102 creating a real-time or near real-time image of what is behind wall 102. This can be of value, for example, when firefighters need to determine what is behind a wall for rescue purposes and/or as part of a method to gain access to another room or when law enforcement officials need to determine whether someone is hiding behind a wall (or similar structure). In FIG. 2(c) the projection of what is behind wall 102, i.e., the two people 106 and 108 in this example, is displayed on the wall 102 itself in locations matching their current position. Alternatively, this projected image can be scaled as desired. According to an exemplary alternate embodiment of the present invention, the projection data can also be transmitted to a hand held unit for display. This hand held unit then generates a projection similar to the one shown in FIG. 2(c) except that the projection is scaled accordingly to fit on the hand held unit's display screen.

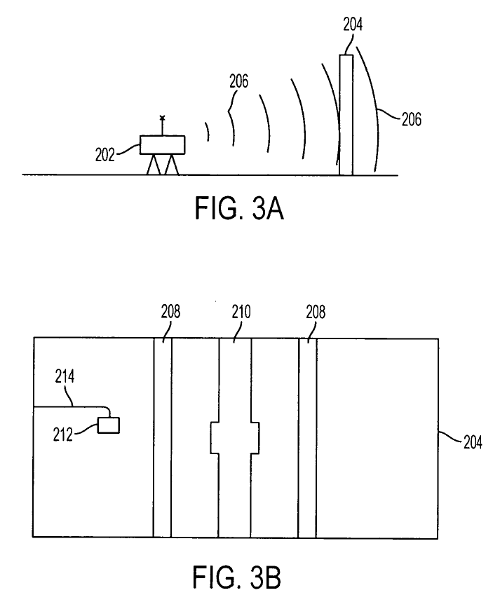

According to another exemplary embodiment, a UWB transmitter/receiver is used to determine what is inside of a structure, such as a wall, as shown in FIGS. 3(a) and 3(b). The UWB transmitter/receiver 202 transmits a signal 206 into wall 204. Depending upon what objects are disposed inside of wall 204, some portion(s) of signal 206 bounces back to the UWB transmitter/receiver 202. This returned signal is processed by the UWB transmitter/receiver 202 and projected upon wall 204. As shown in FIG. 3(b), this projection shows the structure inside of wall 204. For example, inside of wall 204 there are studs 208, piping 210, wiring 214 and an outlet box 212. This projection can cover the whole wall or be scaled down if desired. According to an exemplary alternate embodiment of the present invention, the projection data is transmitted to a hand held unit for display. This hand held unit then generates a projection similar to the one shown in FIG. 3(b) except that the projection is scaled accordingly to fit on the hand held unit's display screen.

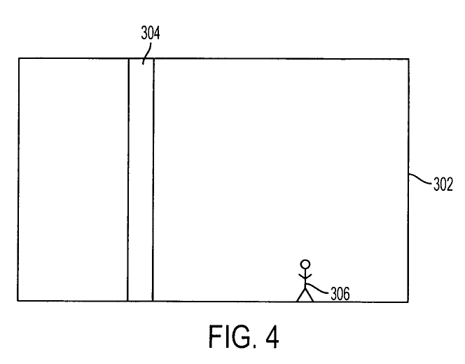

According to another exemplary embodiment, a UWB transmitter/receiver unit can be used to transmit and receive signals that project through a surface such as a wall. If certain objects (such as a metal pipe or a person) are either behind or within the wall, a portion of the transmitted signal bounces back and is received by the UWB transmitter/receiver unit. The unit then processes the signal to create a projection. The projection is displayed upon the surface revealing what is seen behind or within the wall. An exemplary projection (image) is shown in FIG. 4, wherein a wall and the area behind it is currently being scanned and the projection is displayed upon a wall 302 showing the picture, in this case a stud 304 and a person 306.

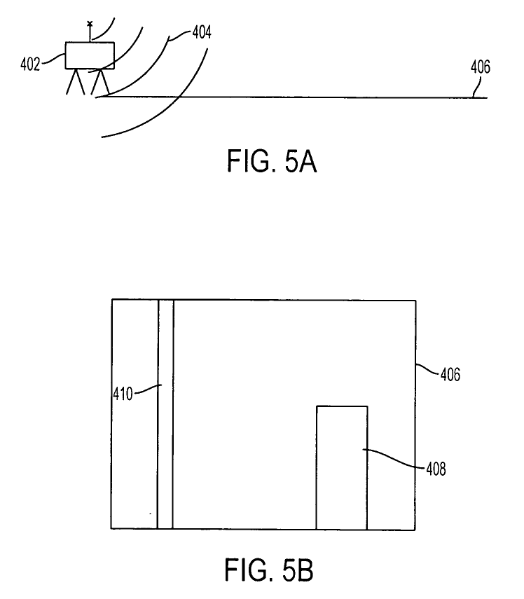

According to yet another exemplary embodiment, a UWB transmitter/receiver unit can be used to transmit and receive signals that project into the ground as illustrated in FIGS. 5(a) and 5(b). In FIG. 5(a) a UWB transmitter/receiver unit 402 is transmitting a signal 404 into the ground 406. Depending upon what object(s) are in the ground, some portion of the transmitted signal 404 will bounce back and be received by the unit 402. This returned signal is then processed by unit 404 and a projection depicting what is underground is projected upon the ground 406 as shown in FIG. 5(b). In this case, a pipe 408 and a cable 410 are underground. This projection can cover the whole ground section which was scanned or be scaled down if desired. According to an exemplary alternate embodiment of the present invention, the projection data is transmitted to a hand held unit for display. This hand held unit then generates a projection similar to the one shown in FIG. 5(b) except that the projection is scaled accordingly to fit on the hand held unit's display screen.

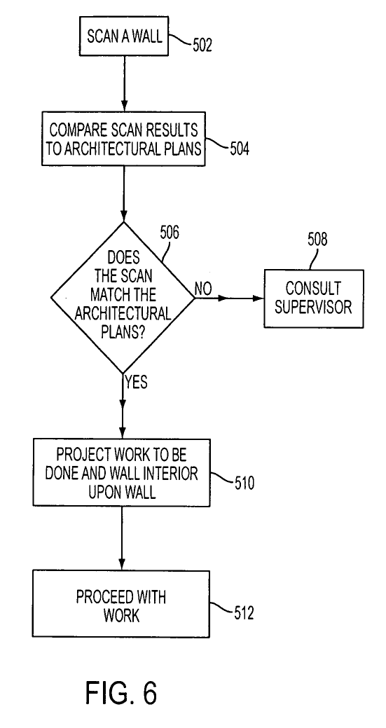

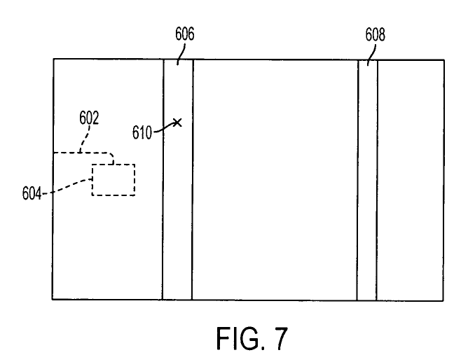

According to still another exemplary embodiment, a UWB transmitter/receiver unit can be coupled to or in communication with architectural data and a work plan as described in the flowchart of FIG. 6 and the projection shown in FIG. 7. For example consider that an electrician is working on a job to install an electrical switch, run some wiring to the switch box and drill a hole for a future cabling job. Initially, the electrician at step 502, uses a UWB transmitter/receiver unit, e.g., as described above, to scan the wall of interest. The UWB device or processor can have the architectural plans already loaded for comparison or can transmit the scan results to another processor (not shown) that has access to the architectural plans. The scanned data is then compared to the architectural data either locally or remotely in step 504. Upon comparison of the scanned data a decision is made (either locally in the UWB unit or remotely by a processor) at step 506 to determine if the scanned data matches the architectural data within some predetermined accuracy tolerance. If the decision is no match, the electrician is notified by the UWB unit, e.g., an alert can be generated by the processor, the job can be stopped and the electrician can inform his/her supervisor of the discrepancy in step 508. If the decision is that the data sets match (yes), the UWB unit projects the work to be done onto the wall and, if desired, also a projection of what was scanned by the UWB unit as being inside of the wall in step 510. The size of the projection can be 1:1 or scaled as desired.

It is to be understood that while the above described examples have referenced buildings and the ground, the UWB unit could be used in other structures and environments. For example, the UWB unit could be used on ships, vehicles, trains or underground mines.

After the projection has been displayed the work can begin in step 512. According to this purely illustrative example, the work includes installing an electrical switch, running some wiring to the switch and drilling a hole for a future cabling job. In FIG. 7, the locations for wiring 602 to be run and the switch 604 to be installed are shown by a projection of dashed lines on the wall indicating either an outline or a location for the work to be performed. Alternatively, other visual indicators could be used to show the work to be performed. Additionally shown in the projection are studs 606, 608 and an “X” 610 marking the drill spot for the future cabling job. Any additional desired information about the job could be projected upon the wall as desired, such as, cable type or drill bit size to be used or any other job instructions. According to an alternate exemplary embodiment, a GPS unit can be attached to the UWB unit to increase accuracy of the comparisons between the data sets described above. Additionally, upon completion of the job (or other similar jobs) a UWB unit can be used to rescan the wall and match the results to the architectural plan to verify that the job was performed correctly.

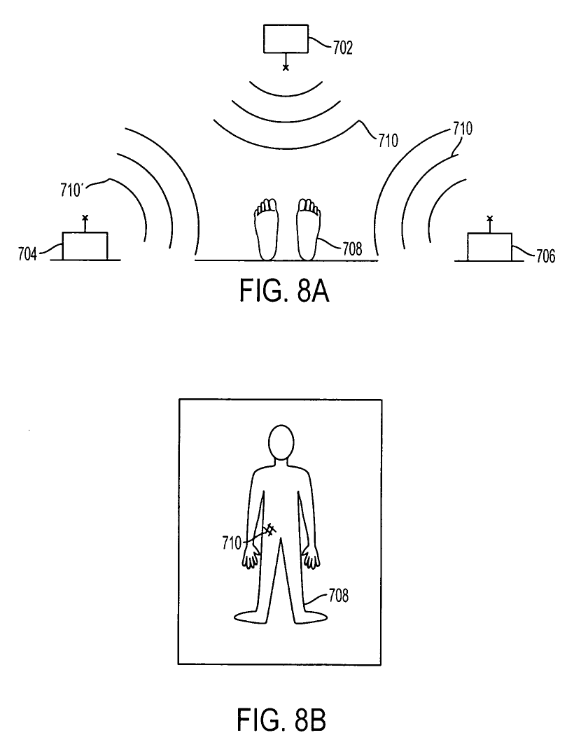

According to another exemplary embodiment, a UWB transmitter/receiver system can be used to scan a human body to search for anomalies and project the information back upon the scanned body as shown in FIGS. 8(a)-(b). FIGS. 8(a)-(b) show different views of the same surgical suite. This UWB transmitter/receiver system shown in FIGS. 8(a)-(b) shows three UWB transmitter/receiver units being used. This number of units is purely illustrative, and depending upon the particular application, more or fewer UWB transceiver units could be used. Initially, as shown in FIG. 7(a), units 702, 704 and 706 emit signals 708 in the UWB frequency range. These signals make contact with patient 708, and a portion of the signal bounces back to each unit 702, 704 and 706. These signals are then sent to a processing unit (not shown) which merges the signals into a projection of what was scanned from person 708. The use of the multiple units 702, 704, and 706 provide data to allow a processor to accurately allow a projection device to perform contour matching of the projection onto person 708. The projection data is sent to a projection device (not shown, but in one exemplary embodiment a part of unit 702) above the patient. The projection unit then projects the picture upon person 708. In FIG. 7(b), the scanned data has been turned into a projection that is being projected down upon person 708. The projection allows the doctor to see whatever anomalies (such as a tumor) exist in the scanned area of interest on person 708. In this example a spot 710, differentiated by shading, is projected upon person 708 showing the location of an anomaly. Additionally, while performing the above described scan, other data can be gathered. For example, if a person had a previous injury which required the insertion of a metal pin, this pin could be found during the scan allowing the medical professionals access to more potentially useful knowledge.

According to another exemplary embodiment, a UWB transmitter/receiver unit can be used to determine material composition. For example, prior to destroying a building, it may be of interest to know what materials are inside of the building. Some materials have reuse value, such as copper and aluminum. Using a UWB transmitter/receiver unit to scan a building (or parts of a building) information is collected. This information can be matched by a computing system (as either part of the unit or remotely) to information specific to materials, such as, metal density. This outcome of this process would allow one to determine if, where and quantity of materials of value are in a building for removal prior to destruction. Additionally, this exemplary embodiment can be expanded to allow for collecting (where available) more building information, such as ownership, occupants and other material related information.

The above-described exemplary embodiments are intended to be illustrative in all respects, rather than restrictive, of the present invention. Thus the present invention is capable of many variations in detailed implementation that can be derived from the description contained herein by a person skilled in the art. For example, frequencies outside of the UWB range could be used depending upon the medium to be scanned. Additionally, other imaging devices, storage devices and communications devices can be coupled either directly or indirectly to the UWB units. An example of another type of imaging device is a thermal imaging device. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A system for imaging comprising:
an emitter, wherein said emitter emits signals toward an area of interest;
a receiver, wherein said receiver receives signals that were emitted by said emitter and reflected from at least one object in said area of interest;
a processor in communication with said emitter, said receiver and a projector, wherein said processor processes said received signals to generate signals for projecting an image associated with said at least one object and transmits said generated signals to said projector; and
said projector, wherein said projector projects said image onto a surface associated with said at least one object.

2. The system of claim 1, wherein said processor has access to architectural data associated with said area of interest and compares said architectural data to said generated signals to determine if said generated signals match said architectural data within a predetermined tolerance.

3. The system of claim 2, wherein if said generated signals do not match said architectural plans within said predetermined tolerance said processor generates an alert.

4. The system of claim 2, wherein said processor has access to job instructions for a job associated with said area of interest and said architectural data.

5. The system of claim 4, wherein said job instructions for said job associated with said area of interest and said architectural data are projected upon or near said area of interest.

6. The system of claim 1, wherein said emitter is an ultrawideband scanner and wherein said emitted signals are in the range of 3.1 GHz to 10.6 GHz.

7. The system of claim 1, wherein said emitted signals are outside of the range of 3.1 GHz to 10.6 GHz.

8. The system of claim 1, wherein said processor transmits said generated signals to a hand held device.

9. The system of claim 1, wherein said area of interest is one of a body, a wall, a room, an underground section or a combination thereof.

10. The system of claim 1, wherein said image is scalable and said projector includes controls for scaling a size of said projected image on said surface.

11. The system of claim 1, further comprising multiple emitters and multiple receivers in communication with a processor.

12. The system of claim 11, wherein said multiple emitters and multiple receivers in communication with a processor are used to scan a person and project anomaly locations upon a person's surface.

13. The system of claim 1, wherein said processor is in communication with another imaging device and said processor is capable of using data from said another imaging device to create said generated signals for projecting.

14. The system of claim 13, wherein said another imaging device is a thermal imaging device.

15. A method for imaging comprising:
emitting signals toward an area of interest by an emitter;
receiving said signals that were emitted by said emitter and reflected from at least one object in said area of interest;
processing said received signals to generate signals for projecting an image associated with said at least one object;
transmitting said generated signals to a projector; and
projecting said image onto a surface associated with said at least one object by said projector.

16. The method of claim 15, wherein said processor has access to architectural data associated with said area of interest and compares said architectural plans to said generated signals to determine if said generated signals match said architectural plans within some predetermined tolerance.

17. The method of claim 16, wherein if said generated signals do not match said architectural data within some predetermined tolerance said processor generates an alert.

18. The method of claim 16, wherein said processor has access to job instruction for a job associated with said area of interest and said architectural plans.

19. The method of claim 18, wherein said job instructions for a job associated with said area of interest and said architectural data are projected upon or near said area of interest.

20. The method of claim 15, wherein said emitter is an ultrawideband scanner and wherein said emitted signals are in the range of 3.1 GHz to 10.6 GHz.

21. The system of claim 15, wherein said emitted signals are outside of the range of 3.1 GHz to 10.6 GHz.

22. The method of claim 15, wherein said processor transmits said generated signals to a hand held device.

23. The method of claim 15, wherein said area of interest is one of a body, a wall, a room, an underground section or a combination thereof.

24. The method of claim 15, wherein said image is scalable and said projector includes controls for scaling a size of said projected image on said surface.

25. The system of claim 15, further comprising multiple emitters and multiple receivers in communication with a processor.

26. The method of claim 25, wherein said multiple emitters and multiple receivers in communication with a processor are used to scan a person and project anomaly locations upon a person's surface.

27. The method of claim 15, wherein said processor is in communication with another imaging device and said processor is capable of using data from said another imaging device to create said generated signals for projecting.

28. The system of claim 27, wherein said another imaging device is a thermal imaging device.
